(19) United States
(12) Patent Application Publication
(10) Pub. No.: US 2024/0209137 A1
(43) Pub. Date: Jun. 27, 2024

(54) REDUCING THE CONCENTRATION OF MONOMERIC POLYISOCYANATES IN POLYURETHANE COMPOSITIONS

(71) Applicant: SIKA TECHNOLOGY AG, Baar (CH)

(72) Inventor: Bernhard REINGARDT, Thalwil (CH)

(73) Assignee: SIKA TECHNOLOGY AG, Baar (CH)

(21) Appl. No.: 18/287,100

(22) PCT Filed: Jun. 22, 2022
(86) PCT No.: PCT/EP2022/067047

§ 371 Date: Oct. 16, 2023

(30) Foreign Application Priority Data
Jun. 24, 2021 (EP) 21181545.1

(51) Int. Cl. C08G 18/12; C08G 18/24; C08G 18/42; C08G 18/48; C08G 18/75; C08G 18/76

(52) U.S. Cl. CPC C08G 18/12; C08G 18/246; C08G 18/4244; C08G 18/4812; C08G 18/4825; C08G 18/4829; C08G 18/755; C08G 18/7671

(57) ABSTRACT

A method for reducing the concentration of monomeric polyisocyanates in a composition containing (i) at least one prepolymer having isocyanate end groups based on at least one polyisocyanate and at least one polyol, and (ii) at least one monomeric polyisocyanate. The method includes the following steps: a) providing the composition containing the prepolymer and the at least one monomeric polyisocyanate; b) reacting the composition with a polycarboxylate and water at a temperature of 40° C., preferably 50-90° C., in particular 60-80° C., particularly preferably 65-75° C., such that the concentration of monomeric polyisocyanate in the composition is reduced.

### TECHNICAL FIELD

The invention relates to a method of reducing the content of monomeric polyisocyanates in a composition comprising (i) at least one prepolymer having isocyanate end groups based on at least one polyisocyanate and at least one polyol, and (ii) at least one monomeric polyisocyanate. The invention further relates to a polyurethane composition and to a method of producing a polyurethane composition. The invention likewise provides for the use of an auxiliary for reducing the content of monomeric polyisocyanates in polyurethane compositions.

### PRIOR ART

Polyurethane compositions have long been known and are used in many sectors, for example as adhesives, sealants or coatings in the building and manufacturing industries. A distinction is made between one-component (1K) and two-component (2K) polyurethane (PUR) compositions. In the case of 1K polyurethane compositions, where all constituents are present in one component, a further distinction can be made between moisture-curing compositions that cure under the influence of air humidity, and heat-curing compositions where curing is induced by heating.

As binders, polyurethane compositions contain polymers having isocyanate end groups that are prepared by reacting polyols with monomeric polyisocyanates, typically diisocyanates. The polymers thus obtained are referred to as prepolymers and, because of chain extension reactions, typically contain a residual content of monomeric polyisocyanates, typically in the range from 1% to 3% by weight.

Monomeric polyisocyanates are potentially harmful to health. Formulations containing monomeric polyisocyanates, in particular above a concentration of 0.1% by weight, must be provided with hazard symbols and warning messages on the label and in the data sheets, and in some countries may be subject to regulations in respect of sale and use.

There are various approaches to providing polymers containing isocyanate groups with a low monomeric polyisocyanate content. One way is to use the monomeric polyisocyanate in deficiency in the preparation of the polymer. However, this gives rise to highly chain-extended polymers having very high viscosity that lead to problems with storage stability and processibility of the products. A further route is to partly react the polymer containing isocyanate groups with a functional compound, for example a mercaptosilane, aminosilane or hydroxyaldimine. The reaction products obtained, however, have different crosslinking characteristics and likewise greatly elevated viscosity, and have only limited storage stability and processibility.

EP 2,439,219 describes the use of silicon dioxide having surface amino groups for reduction of the monomeric diisocyanate content. However, the specific silicon dioxide is costly and likewise leads to high viscosities.

EP 1,975,186 teaches a method of reducing the content of monomeric diisocyanates in compositions containing polyurethane polymers having isocyanate groups, used as hotmelt adhesives in particular, wherein specific polyaldimines and water react selectively with the monomeric diisocyanates present in the composition. However, this method requires the use of costly specific aldimine additives that can additionally react with the polyurethane polymers under hydrolysis and hence limit freedom of formulation and use of the composition.

In terms of product properties, the most attractive route to polymers containing isocyanate groups that have a low monomeric polyisocyanate content is to use the monomeric polyisocyanate in excess in the preparation of the polymer and then to remove the majority of the unconverted monomeric polyisocyanate by means of a suitable separation method, especially by means of distillation. Polymers from this process have comparatively low viscosity and a low residual monomeric polyisocyanate content, and are of excellent suitability for production of polyurethane compositions having a low monomer level which have good storage stability and good application properties. However, a particular disadvantage with this approach is that it is necessary to conduct complex separation methods that require additional apparatus and make the production of the polymers more costly.

There is therefore still a need for improved solutions that have the disadvantages mentioned to a lesser degree, if at all.

### SUMMARY OF THE INVENTION

It is therefore an object of the invention to provide improved solutions for preparation of polymers containing isocyanate groups with a low monomeric polyisocyanate content. The solutions are to be very efficient, inexpensive, and implementable with low apparatus complexity. At the same time, polyurethane compositions having very good properties are to be obtainable, especially with regard to storage stability, processibility, curability and mechanical properties.

It has been found that, surprisingly, the object can be achieved by the method as claimed in claim 1. The core of the invention is accordingly a method of reducing the content of monomeric polyisocyanates in a composition comprising (i) at least one prepolymer having isocyanate end groups based on at least one polyisocyanate and at least one polyol, and (ii) at least one monomeric polyisocyanate, wherein the method comprises the following steps:
a) providing the composition comprising the prepolymer and the at least one monomeric isocyanate;
b) reacting the composition with a polycarboxylate and water at a temperature of at least 40° C., preferably 50-90° C., in particular 60-80° C., more preferably 65-75° C., such that the content of monomeric polyisocyanate in the composition is reduced.

It has been found that the reaction with water and polycarboxylate can reduce the content of monomeric polyisocyanate in a controlled manner, it being possible without difficulty to lower the monomeric polyisocyanate content to below 0.1% by weight.

The compositions obtainable in accordance with the invention with a reduced monomeric polyisocyanate content may additionally be used as a basis for 1K polyurethane compositions without resulting in significant impairments in relation to storage stability, processibility, curability and mechanical properties of the 1K polyurethane compositions.

The method can additionally be conducted entirely in apparatuses that are typically used for the production of prepolymers. Accordingly, it is possible to reduce apparatus complexity and costs. It is likewise advantageous that step b) of the method of the invention, if desired, can directly follow the preparation of the prepolymer without needing to cool down the reaction mixture, which saves additional energy.

Further aspects of the invention are the subject of further independent claims. Particularly preferred embodiments of the invention are the subject matter of the dependent claims.

### MODE OF EXECUTION OF THE INVENTION

A first aspect of the present invention relates to a method of reducing the content of monomeric polyisocyanates in a composition comprising (i) at least one prepolymer having isocyanate end groups based on at least one polyisocyanate and at least one polyol, and (ii) at least one monomeric polyisocyanate, wherein the method comprises the following steps:
a) providing the composition comprising the prepolymer and the at least one monomeric polyisocyanate;
b) reacting the composition with a polycarboxylate and water at a temperature of at least 40° C., preferably 50-90° C., in particular 60-80° C., more preferably 65-75° C., such that the content of monomeric polyisocyanate in the composition is reduced.

Compound names beginning with “poly” refer to substances containing two or more of the functional groups that occur in their name per molecule. The compounds may be monomeric, oligomeric or polymeric compounds. A polyol is, for example, a compound having two or more hydroxyl groups. A polyisocyanate is a compound having two or more isocyanate groups.

Isocyanate-reactive compounds are compounds that have at least one isocyanate-reactive group that can react with isocyanate groups to form a chemical bond.

A one-component polyurethane composition is a composition where the constituents are present in one component. In general, a one-component composition is storage-stable at least over a certain period of time at room temperature (e.g. 23° C.) and, if the system is moisture-curable, with exclusion of air humidity.

The term “storage-stable” relates to the property of a substance or composition of being storable at room temperature in a suitable container over several weeks up to 6 months or more without any change in its application or use properties to a degree of relevance for the use thereof as a result of the storage.

Average molecular weight here means the number-average molecular weight (Mₙ), which can be determined by gel permeation chromatography (GPC) against polystyrene standard.

All the details that follow, especially with regard to the method, to the polyurethane composition and to the uses, are naturally equally applicable to the method of the invention, the uses of the invention and the polyurethane compositions obtainable therefrom, even if this is not pointed out specifically.

Thermal curing is understood to mean curing at an elevated temperature of, for example, at least 80° C., in particular at least 100° C., especially more than 120° C. Thermal curing is especially conducted at a temperature above the melting point of the nitrogen compound.

In the case of thermal curing, the polyurethane composition is simultaneously cured throughout after application. By contrast, in the case of moisture curing, there is diffusion-controlled curing of the polyurethane composition after application from the outside inward. Moisture curing is understood to mean curing under moisture, especially air humidity. Moisture curing is generally conducted at a temperature of not more than 40° C., where moisture curing is usually conducted at room temperature, i.e., for example, at temperatures below 35° C., for example about 23° C.

The composition used in accordance with the invention in step a) comprises at least one prepolymer with isocyanate end groups, formed from at least one polyisocyanate and at least one polyol. There may also be mixtures of two or more prepolymers of this kind. Prepolymers with isocyanate end groups are known to the person skilled in the art. The prepolymer has at least two isocyanate end groups and preferably exactly two isocyanate end groups. By means of the isocyanate end groups, the prepolymer can be chain-extended or crosslinked by reaction with compounds having isocyanate-reactive groups, for example water, hydroxyl groups or amine groups, which brings about the curing of the composition. The terms “curing” or “crosslinking” also include chain extension reactions hereinafter.

The prepolymer having isocyanate end groups, formed from at least one polyisocyanate and at least one polyol, is a polyurethane prepolymer which is prepared by reaction of at least one polyisocyanate and at least one polyol. The person skilled in the art is able to prepare such prepolymers directly.

Likewise a constituent of the composition provided in accordance with the invention is at least one monomeric polyisocyanate. This especially corresponds to the at least one polyisocyanate on which the prepolymer is based or which is used for production of the prepolymer. In principle, however, there may alternatively or additionally also be other monomeric polyisocyanates.

A monomeric polyisocyanate content in the composition provided in step a) is in particular more than 0.5% by weight, especially more than 1% by weight, specifically more than 2% by weight, based on the composition. In particular, the proportion of the composition provided in step a) is 0.6-15% by weight, specifically 1-10% by weight, in particular 2-5% by weight, based on the composition. The composition just mentioned may consist predominantly or exclusively of prepolymer and monomeric polyisocyanate.

In step a), it is possible to provide an already previously produced composition comprising the prepolymer and the at least one monomeric polyisocyanate, or the composition comprising the prepolymer and the at least one monomeric polyisocyanate may be produced in step a) by reacting at least one polyol with at least one polyisocyanate, leaving residues of the monomeric polyisocyanate unreacted in the reaction mixture. In an advantageous embodiment, the composition is provided in step a) by reacting at least one polyisocyanate and at least one polyol to give the prepolymer having isocyanate end groups. Because the conversion is never entirely complete, the composition will always include a certain content of monomeric polyisocyanate.

The reaction of the at least one polyol with at least one polyisocyanate can be effected, for example, by reacting the polyol component and the polyisocyanate component by customary methods, for example at temperatures of 50 to 100° C., optionally in the presence of a suitable catalyst, wherein the polyisocyanate is used in a stoichiometric excess. It is optionally possible if necessary to add additives to the reaction mixture, such as solvents and/or plasticizers. The reaction product formed is the prepolymer with isocyanate end groups. Solvents, if used, can be removed again after the reaction. Plasticizers, if used, can preferably remain in the product obtained.

The polyisocyanate for formation of the prepolymer having isocyanate end groups is preferably a polyisocyanate, especially a diisocyanate, selected from aliphatic polyisocyanates and/or aromatic polyisocyanates. It is possible to use one such polyisocyanate or two or more such polyisocyanates. Preference is given to an aromatic polyisocyanate or an aliphatic polyisocyanate or a mixture of at least one aliphatic and at least one aromatic polyisocyanate.

An aliphatic polyisocyanate is an aliphatic compound having at least two isocyanate groups. Preference is given to an aliphatic diisocyanate. The aliphatic polyisocyanate may be an acyclic or cyclic aliphatic polyisocyanate, preference being given to a cyclic aliphatic polyisocyanate. Preference is given to a saturated aliphatic polyisocyanate. These polyisocyanates are known and commercially available.

Examples of a suitable aliphatic polyisocyanate are hexamethylene 1,6-diisocyanate, 2,2,4- and 2,4,4-trimethylhexamethylene 1,6-diisocyanate, dodecamethylene 1,12-diisocyanate, cyclobutane 1,3-diisocyanate, cyclohexane 1,3- and 1,4-diisocyanate and mixtures of these isomers, isophorone diisocyanate (IPDI, 1-isocyanato-3,3,5-trimethyl-5-isocyanatomethylcyclohexane), hexahydrotolylene 2,4- and 2,6-diisocyanate, hexahydrophenyl 1,3- and 1,4-diisocyanate, perhydro(diphenylmethane 2,4′- and -4,4′-diisocyanate), and mixtures of the aforementioned isocyanates.

Particular preference is given to isophorone diisocyanate (IPDI) and hexamethylene 1,6-diisocyanate (HDI).

Examples of a suitable aromatic polyisocyanate are diphenylmethane 4,4′-diisocyanate, optionally with fractions of diphenylmethane 2,4′- and/or 2,2′-diisocyanate (MDI), tolylene 2,4-diisocyanate or mixtures thereof with tolylene 2,6-diisocyanate (TDI), phenylene 1,4-diisocyanate (PDI), and/or naphthalene 1,5-diisocyanate (NDI).

More preferably, the polyisocyanate comprises a diphenylmethane diisocyanate, preferably a diphenylmethane 4,4′-diisocyanate, optionally with fractions of diphenylmethane 2,4′- and/or 2,2′-diisocyanate (MDI). It is possible to reduce the level of such monomeric polyisocyanates particularly effectively by the method of the invention.

In order to form the prepolymer having isocyanate end groups, the at least one polyisocyanate is reacted with one or more polyols. It is possible to use any of the polyols that are customary for polyurethane chemistry. Suitable polyols are commercially available in a wide variety.

The polyol preferably has a number-average molecular weight or, if it is a nonpolymeric polyol, a molecular weight of 250 to 30 000 g/mol and preferably of 400 to 20 000 g/mol.

The polyol also preferably has an average OH functionality in the range from 1.6 to 3. It will be appreciated that polymeric compounds may also include substances that are formed from side reactions and have, for example, just one or no hydroxyl group.

The polyol is preferably a diol or triol having an OH number in the range from 8 to 185 mg KOH/g, especially in the range from 10 to 120 mg KOH/g.

Polyols used may, for example, be the following commercial polyols or mixtures thereof:
a) polyoxyalkylene polyols, also called polyether polyols or oligoetherols, that are polymerization products of ethylene oxide, 1,2-propylene oxide, 1,2- or 2,3-butylene oxide, oxetane, tetrahydrofuran or mixtures thereof, possibly polymerized with the aid of a starter molecule having two or more active hydrogen atoms, such as water, ammonia or compounds having two or more OH or NH groups, for example ethane-1,2-diol, propane-1,2- and -1,3-diol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, cyclohexane-1,3- and -1,4-dimethanol, bisphenol A, hydrogenated bisphenol A, 1,1,1-trimethylolethane, 1,1,1-trimethylolpropane, glycerol, aniline, and mixtures of the aforementioned compounds. It is possible to use either polyoxyalkylene polyols having a low degree of unsaturation (measured to ASTM D-2849-69 and reported in milliequivalents of unsaturation per gram of polyol (meq/g)), prepared, for example, with the aid of what are called double metal cyanide complex catalysts (DMC catalysts), or polyoxyalkylene polyols having a higher degree of unsaturation, for example prepared with the aid of anionic catalysts such as NaOH, KOH, CsOH or alkali metal alkoxides.
   Polyoxyalkylene diols or polyoxyalkylene triols are particularly suitable, especially polyoxyethylene- and polyoxypropylene di- or triols. Polyoxyalkylene diols and triols having a degree of unsaturation of less than 0.02 meq/g and having an average molecular weight in the range from 1000 to 30 000 g/mol are especially suitable, as are polyoxypropylene diols and triols having an average molecular weight of 400 to 8000 g/mol.
   Likewise particularly suitable are so-called ethylene oxide-terminated (“EO-endcapped”, ethylene oxide-endcapped) polyoxypropylene polyols. The latter are special polyoxypropylene polyoxyethylene polyols that are obtained for example when pure polyoxypropylene polyols, especially polyoxypropylene diols and triols, are at the end of the polypropoxylation reaction further alkoxylated with ethylene oxide and thus have primary hydroxyl groups.
b) Styrene-acrylonitrile- or acrylonitrile-methyl methacrylate-grafted polyether polyols.
c) Polyester polyols, also called oligoesterols, prepared by known methods, especially the polycondensation of hydroxycarboxylic acids or the polycondensation of aliphatic and/or aromatic polycarboxylic acids with di- or polyhydric alcohols.
   Especially suitable polyester polyols are those that are prepared from di- to trihydric, especially dihydric, alcohols, for example ethylene glycol, diethylene glycol, propylene glycol, dipropylene glycol, neopentyl glycol, butane-1,4-diol, pentane-1,5-diol, 3-methylhexane-1,5-diol, hexane-1,6-diol, octane-1,8-diol, decane-1,10-diol, dodecane-1,12-diol, 1,12-hydroxystearyl alcohol, 1,4-cyclohexanedimethanol, dimer fatty acid diol (dimer diol), neopentyl glycol hydroxypivalate, glycerol, 1,1,1-trimethylolpropane or mixtures of the aforementioned alcohols, with organic di- or tricarboxylic acids, especially dicarboxylic acids, or anhydrides or esters thereof, for example succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid and trimellitic anhydride, or mixtures of the aforementioned acids, and also polyester polyols formed from lactones, for example from 8-caprolactone and starters such as the aforementioned di- or trihydric alcohols.
d) Polycarbonate polyols as obtainable, for example, by reaction of the abovementioned alcohols—used to form the polyester polyols—with dialkyl carbonates, diaryl carbonates or phosgene.
e) Block copolymers bearing at least two hydroxyl groups and having at least two different blocks having polyether, polyester and/or polycarbonate structure of the type described above, especially polyether polyester polyols.
f) Polyacrylate polyols and polymethacrylate polyols.
g) Polyhydroxy-functional fats and oils, for example natural fats and oils, especially castor oil; or polyols obtained by chemical modification of natural fats and oils—called oleochemical polyols—for example the epoxy polyesters or epoxy polyethers obtained by epoxidation of unsaturated oils and subsequent ring opening with carboxylic acids or alcohols, or polyols obtained by hydroformylation and hydrogenation of unsaturated oils; or polyols obtained from natural fats and oils by degradation processes such as alcoholysis or ozonolysis and subsequent chemical linkage, for example by transesterification or dimerization, of the degradation products or derivatives thereof thus obtained. Suitable degradation products of natural fats and oils are especially fatty acids and fatty alcohols, and also fatty acid esters, especially the methyl esters (FAME), which can be derivatized, for example, by hydroformylation and hydrogenation to give hydroxy fatty acid esters.
h) Polyhydrocarbon polyols, also called oligohydrocarbonols, for example polyhydroxy-functional polyolefins, polyisobutylenes, polyisoprenes; polyhydroxy-functional ethylene/propylene, ethylene/butylene or ethylene/propylene/diene copolymers; polyhydroxy-functional polymers of dienes, especially of 1,3-butadiene, which can especially also be prepared from anionic polymerization; polyhydroxy-functional copolymers of dienes, such as 1,3-butadiene, or diene mixtures and vinyl monomers, such as styrene, acrylonitrile, vinyl chloride, vinyl acetate, vinyl alcohol, isobutylene and isoprene, for example polyhydroxy-functional acrylonitrile/butadiene copolymers, as can be prepared, for example, from epoxides or aminoalcohols and carboxyl-terminated acrylonitrile/butadiene copolymers; and hydrogenated polyhydroxy-functional polymers or copolymers of dienes.

In the preparation of the prepolymer, the OH groups of the polyol react with the isocyanate groups of the monomeric polyisocyanate, especially the monomeric diisocyanate. This results also in what are called chain extension reactions, in that there is reaction of OH groups and/or isocyanate groups of products of the reaction between polyol and monomeric polyisocyanate. The higher the NCO/OH ratio chosen, the lower the level of chain extension reactions that takes place, and the lower the polydispersity and hence the viscosity of the polymer obtained. A measure of the chain extension reaction is the average molecular weight of the polymer, or the breadth and distribution of the peaks in the GPC analysis. A further measure is the effective NCO content of the polymer freed of monomers relative to the theoretical NCO content calculated from the reaction of every OH group with a monomeric polyisocyanate.

The NCO/OH ratio in the reaction between polyisocyanate and the polyol is preferably in the range from 1.3/1 to 10/1, more preferably in the range from 1.3/1 to 2.5/1.

The residual unreacted polyisocyanate content after the reaction is preferably not more than 3% by weight, especially not more than 2% by weight, based on the overall reaction product.

The prepolymer preferably has an NCO content in the range from 0.5% to 10% by weight, preferably 0.6% to 8.4% by weight, especially 0.8% to 7% by weight, based on the prepolymer.

Such prepolymers are particularly suitable for the production of formulations such as, in particular, elastic adhesives, sealants and coatings which, after conversion by step b) of the method of the invention, have a content of monomeric polyisocyanates, especially monomeric diisocyanates, of less than 0.1% by weight; these can be safely handled even without special safety precautions and can thus be sold in many countries without hazard labeling.

The reaction between the polyisocyanate and the polyol for preparation of the prepolymer is preferably conducted with exclusion of moisture at a temperature in the range from 20 to 160° C., especially 40 to 140° C., optionally in the presence of suitable catalysts.

The reaction in step b) is conducted in such a way that the monomeric polyisocyanate content in the composition is reduced. This is particularly successful when the polycarboxylate is added to the residual monomer-containing prepolymer only when the prepolymer has already been heated to reaction temperature of at least 40° C.

In particular, the reaction in step b) is conducted in such a way that, based on the monomeric polyisocyanate content present before step b), especially of monomeric diisocyanates, a decrease in the monomeric polyisocyanate content of at least 10% by weight, especially at least 50% by weight, specifically at least 75% by weight, in particular at least 90% by weight or at least 95% by weight, is achieved.

Preferably, the reaction in step b) is conducted in such a way as to result in a content of monomeric polyisocyanates, specifically monomeric diisocyanates, of not more than 0.5% by weight, preferably not more than 0.3% by weight, especially not more than 0.1% by weight, specifically less than 0.1% by weight, based on the composition.

It has been found to be appropriate when the composition is reacted in step b) at reaction temperature for at least 5 min, preferably 10-120 min, in particular 15-60 min. This leads to a significant reduction in the monomeric polyisocyanate content.

It is advantageous when the polycarboxylate and the water are mixed with the composition in step d), and the mixture is preferably mixed intermittently or throughout the reaction. This can accelerate the conversion. Mixing apparatuses used in the present context may be any of the mixing apparatuses known in this field.

The polycarboxylate and the water may be added simultaneously, for example as a mixture, or sequentially. It is advantageous here when the polycarboxylate is already present when water is added or is added simultaneously. In a preferred embodiment, the polycarboxylate is preliminarily admixed with water, for example by spraying, and then added as a polycarboxylate/water mixture in step b). In a further preferred embodiment, the polycarboxylate is first added and preferably mixed in in the mixture, and then the water is metered in.

In particular, the method of the invention is conducted without a separation step for removal of monomeric polyisocyanate, especially without distillative removal of monomeric polyisocyanate. In specific variants, however, it is possible in principle to remove a portion of the monomeric polyisocyanate by a suitable separation method. A preferred separation method is a distillative method, especially thin-film distillation or short-path distillation, preferably with application of reduced pressure.

The polycarboxylate is especially a polycarboxylate ether. Further preferably, the polycarboxylate is a comb polymer having a polycarboxylate backbone and polyether side chains, wherein the polyether side chains are bonded to the polycarboxylate backbone via ester, ether, amide and/or imide groups.

More preferably, the polycarboxylate is a polymer P having or consisting of the following component structural units:
a) a molar parts of a component structural unit S1 of the formula I

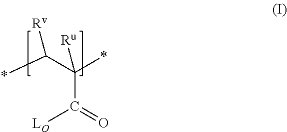

b) b molar parts of a component structural unit S2 of the formula II

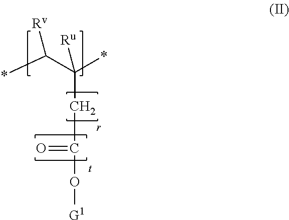

c) c molar parts of a component structural unit S3 of the formula (III)

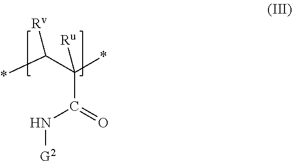

d) d molar parts of a component structural unit S4 of the formula (IV)

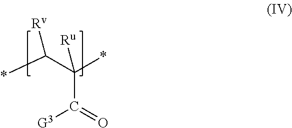

where
   L independently represents H*, an alkali metal ion, alkaline earth metal ion, a di- or trivalent metal ion, an ammonium ion or an organic ammonium group,
   each R^{u} independently of the others is hydrogen or a methyl group,
   each R^{v} independently of the others is hydrogen or COOM,
   r=0, 1 or 2,
   t=0 or 1,
   G¹ and G² are independently a C₁- to C₂₀-alkyl group, -cycloalkyl group, -alkylaryl group or -[A′O]ₛ-G⁴, where A′=C₂- to C₄-alkylene, G⁴ is H, a C₁- to C₂₀-alkyl group, -cycloalkyl group or -alkylaryl group, and s=2-250,
   G³ are independently NH₂, —NG⁵G⁶, —OG⁷NG⁸G⁹, where G⁵ and G⁶ are independently
      a C₁- to C₂₀-alkyl group, -cycloalkyl group,
      alkylaryl group or -aryl group,
      or is a hydroxyalkyl group or is an acetoxyethyl (CH₃—CO—O—CH₂—CH₂—) or a hydroxyisopropyl (HO—CH(CH₃)—CH₂—) or an acetoxyisopropyl group (CH₃—CO—O—CH(CH₃)—CH₂—);
      or G⁵ and G⁶ together form a ring of which the nitrogen is part, in order to form a morpholine or imidazoline ring;
      G⁷ is a C₂-C₄-alkylene group,
      G⁸ and G⁹ each independently represent a C₁- to C₂₀-alkyl group, -cycloalkyl group, -alkylaryl group, -aryl group or a hydroxyalkyl group,
   and where a, b, c and d represent molar proportions of the respective component structural units S1, S2, S3 and S4, with
a/b/c/d=(0.1-0.9)/(0.1-0.9)/(0-0.8)/(0-0.8),
especially a/b/c/d=(0.3-0.9)/(0.1-0.7)/(0-0.6)/(0-0.4),
preferably a/b/c/d=(0.5-0.8)/(0.2-0.4)/(0.001-0.005)/0,
and with the proviso that a+b+c+d=1.

The sequence of component structural units S1, S2, S3 and S4 may be alternating, blockwise or random. It is also possible that the one or more component structural units S1, S2, S3 and S4 form a gradient structure. In principle, it is also possible that there are further structural units in addition to the component structural units S1, S2, S3 and S4. In particular, the sequences of component structural units S1, S2, S3 and S4 in polymer P are random or statistical.

Preferably, the component structural units S1, S2, S3, and S4 together have a proportion by weight of at least 50% by weight, especially at least 90% by weight, most preferably at least 95% by weight, in the total weight of the polymer P.

The preparation of the polymers P is known per se to the person skilled in the art and can be effected, for example, by free-radical polymerization of the corresponding monomers of the formula (Iₘ), (IIₘ), (IIIₘ) or (IVₘ), which leads to a polymer P having the component structural units S1, S2, S3 and S4. The R^{u}, R^{v}, G¹, G², G³, L, r and t radicals are defined here as described above in connection with the polymer P.

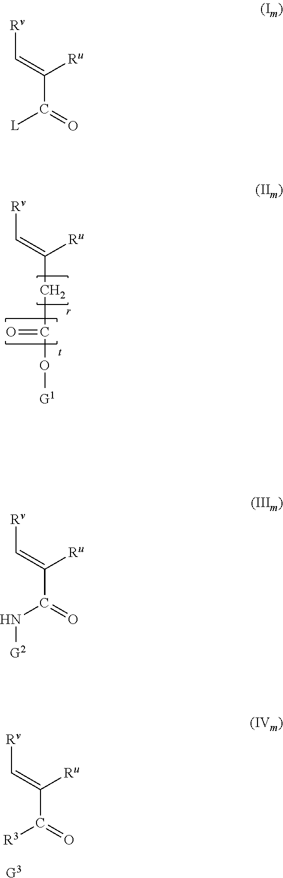

Likewise possible is the preparation of the polymers P by polymer-analogous reaction of a polycarboxylic acid of the formula (V).

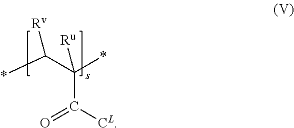

In the polymer-analogous reaction, the polycarboxylic acid of the formula (V) is esterified/amidated with the corresponding alcohols or amines (e.g. HO-G¹, H₂N-G², H-G³) and then at most neutralized or partly neutralized (depending on the nature of the L radical, for example, with metal hydroxides or ammonia). The L radicals and the parameter s are defined here as described above in connection with the polymer P. Details of the polymer-analogous reaction are disclosed, for example, in EP 1 138 697 B1 at page 7 line 20 to page 8 line 50 and in the examples thereof, or in EP 1 061 089 B1 at page 4 line 54 to page 5 line 38 and in the examples thereof. In a variant thereof, as described in EP 1 348 729 A1 at page 3 to page 5 and in the examples thereof, the polymer may be produced in a solid state of matter. This disclosure of these cited patents is hereby incorporated by reference.

In the polymer P, R^{v} especially represents hydrogen, and R^{u} is preferably hydrogen and/or a methyl group.

Preferably, in the polymer P, r=0 and t=1. Also advantageously, r=1-2 and t=0.

G¹ and/or G² in the polymer P, in each case independently, are advantageously -[A′O]ₛ-G⁴ with s=8-200, especially 20-150, specifically 50-130, for example 80-120, and A′ is a C₂- to C₄-alkylene.

In the polymer P, G⁴, in each case independently, is preferably hydrogen or a methyl group.

Very particularly advantageous polymers P are those where
a) the R^{u} and RY radicals are hydrogen,
b) r=0,
c) t=1,
d) G¹ and G², in each case independently, are -[A′O]ₛ-G⁴ with s=8-200, especially 20-120, and A′=C₂-alkylene,
e) G⁴ represents a methyl group and/or
f) a/b/c/d=(0.5−0.8)/(0.2−0.4)/(0.001−0.005)/0

Preferably, features a)-e) are satisfied in combination, and specifically also feature f) in addition. Such a polymer P that fulfills the above features a)-e) in combination is, for example, ViscoCrete®-520 P, available from Sika Schweiz.

Likewise advantageous polymers P are those where
a) t=0 and r=1-2,
b) G¹, in each case independently, is -[A′O]ₛ-G⁴ with s=8-200, especially 20-120,
c) G⁴ represents hydrogen or a methyl group, especially hydrogen, and/or
d) A′ is a C₂- to C₄-alkylene, especially a C₂-alkylene.

Preferably, features a)-d) are satisfied in combination.

A weight-average molecular weight (Mw) of the polycarboxylate, especially of polymer P, is especially 5′000-150′000 g/mol, preferably 10′000-100′000 g/mol, especially 20′000-90′000 g/mol. Weight-average molecular weight (Mw) is determined by gel permeation chromatography (GPC) using polyethylene glycol (PEG) as standard.

The polycarboxylate, especially the polymer P, is preferably used in solid form, specifically in powder form.

Corresponding polymers P are also sold commercially by Sika Schweiz AG in the range with the ViscoCrete® trade name.

Preferably, the polycarboxylate is used in a proportion of 0.5-20% by weight, preferably 1-15% by weight, especially 2-12% by weight, based on the weight of the prepolymer.

Water is preferably used in a proportion of 0.001-1% by weight, preferably 0.02-0.35% by weight, more preferably 0.04-0.6% by weight, based on the weight of the prepolymer.

More preferably, the water is used in a proportion of 0.5-10% by weight, preferably 1-7% by weight, more preferably 2-5% by weight, based on the weight of the polycarboxylate.

In a particularly preferred embodiment, the polycarboxylate and the water are used in the form of a mixture of pulverulent polycarboxylate and water. For this purpose, the water may, for example, be sprayed onto the polycarboxylate. However, it is sufficient in most cases to spread the polycarboxylate, for example in powder form, over a large area in order to enable uptake of water via absorption of air humidity. In the latter case, relative air humidity is preferably between 40% and 60% at a temperature of 23° C.

In a further advantageous embodiment, the composition which is provided in step a) comprises one or more additives and/or one or more additives are added to the composition before, during and/or after step b). The additives are especially auxiliaries and additions that are used customarily in the polyurethane industry.

The additives are especially mixed in. Mixing devices used may be any of the mixing devices known in this field.

In particular, the additive is selected from oligomeric isocyanates, catalysts, fillers, plasticizers, pigments, fibers, nanofillers, dyes, desiccants, adhesion promoters, rheology modifiers, solvents, natural resins, fats or oils, nonreactive polymers, flame-retardant substances, wetting agents, levelling agents, defoamers, deaerating agents, stabilizers against oxidation, against heat, against light or against UV radiation, biocides or mixtures thereof.

Suitable oligomeric isocyanates are especially HDI biurets such as Desmodur® N 100 or N 3200 (from Covestro), Tolonate® HDB or HDB-LV (from Vencorex) or Duranate® 24A-100 (from Asahi Kasei); HDI isocyanurates such as Desmodur® N 3300, N 3600 or N 3790 BA (all from Covestro), Tolonate® HDT, HDT-LV or HDT-LV2 (from Vencorex), Duranate® TPA-100 or THA-100 (from Asahi Kasei) or Coronate® HX (from Nippon Polyurethane); HDI uretdiones such as Desmodur® N 3400 (from Covestro); HDI iminooxadiazinediones such as Desmodur® XP 2410 (from Covestro); HDI allophanates such as Desmodur® VP LS 2102 (from Covestro); IPDI isocyanurates in solution, for example as Desmodur® Z 4470 (from Covestro), or in solid form, for example as Vestanat® T1890/100 (from Evonik); TDI oligomers such as Desmodur® IL (from Covestro); or mixed isocyanurates based on TDI/HDI, such as Desmodur® HL (from Covestro).

Suitable catalysts are in particular catalysts for accelerating the reaction of isocyanate groups, in particular organotin(IV) compounds, such as, in particular, dibutyltin diacetate, dibutyltin dilaurate, dibutyltin dichloride, dibutyltin diacetylacetonate, dimethyltin dilaurate, dioctyltin diacetate, dioctyltin dilaurate or dioctyltin diacetylacetonate, complexes of bismuth(III) or zirconium(IV), in particular with ligands selected from alkoxides, carboxylates, 1,3-diketonates, oxinate, 1,3-ketoesterates, and 1,3-ketoamidates, or compounds containing tertiary amino groups, such as, in particular, 2,2′-dimorpholinodiethyl ether (DMDEE), and amidine or guanidine compounds. Also especially suitable are combinations of different catalysts.

Catalysts are present here for the acceleration of the reaction of isocyanate groups especially only in such an amount that the stability of the cured composition is not unduly impaired.

Suitable fillers are especially ground or precipitated calcium carbonates, optionally coated with fatty acids, especially stearates, barytes, quartz flours, quartz sands, dolomites, wollastonites, calcined kaolins, sheet silicates, such as mica or talc, zeolites, aluminum hydroxides, magnesium hydroxides, silicas, including finely divided silicas from pyrolysis processes, cements, gypsums, fly ashes, industrially produced carbon blacks, graphite, metal powders, for example of aluminum, copper, iron, silver or steel, PVC powders or hollow beads.

Preference is given to calcium carbonates that have optionally been coated with fatty acids, especially stearates, calcined kaolins or industrially produced carbon blacks.

Suitable plasticizers are especially carboxylic acid esters, such as phthalates, especially diisononyl phthalate (DINP), diisodecyl phthalate (DIDP) or di(2-propylheptyl) phthalate (DPHP), hydrogenated phthalates, especially hydrogenated diisononyl phthalate or diisononyl cyclohexane-1,2-dicarboxylate (DINCH), terephthalates, especially bis(2-ethylhexyl) terephthalate or diisononyl terephthalate, hydrogenated terephthalates, especially hydrogenated bis(2-ethylhexyl) terephthalate or diisononyl terephthalate, or bis(2-ethylhexyl) cyclohexane-1,4-dicarboxylate, trimellitates, adipates, especially dioctyl adipate, azelates, sebacates, benzoates, glycol ethers, glycol esters, organic phosphoric or sulfonic acid esters, polybutenes, polyisobutenes or plasticizers derived from natural fats or oils, especially epoxidized soybean or linseed oil.

Also advantageous are additives selected from:
inorganic or organic pigments, especially titanium dioxide, chromium oxides or iron oxides;
fibers, in particular glass fibers, carbon fibers, metal fibers, ceramic fibers, polymer fibers, such as polyamide fibers or polyethylene fibers, or natural fibers, such as wool, cellulose, hemp or sisal;
nanofillers such as graphene or carbon nanotubes;
dyes;
desiccants, especially molecular sieve powder, calcium oxide, highly reactive isocyanates such as p-tosyl isocyanate, monooxazolidines such as Incozol® 2 (from Incorez) or orthoformic esters;
adhesion promoters, in particular organoalkoxysilanes, in particular epoxysilanes, such as in particular 3-glycidoxypropyltrimethoxysilane or 3-glycidoxypropyltriethoxysilane, (meth)acrylosilanes, anhydridosilanes, carbamatosilanes, alkylsilanes or iminosilanes, or oligomeric forms of these silanes, or titanates;
further catalysts which accelerate the reaction of the isocyanate groups, especially salts, soaps or complexes of tin, zinc, bismuth, iron, aluminum, molybdenum, dioxomolybdenum, titanium, zirconium or potassium, especially tin(II) 2-ethylhexanoate, tin(II) neodecanoate, zinc(II) acetate, zinc(II) 2-ethylhexanoate, zinc(II) laurate, zinc(II) acetylacetonate, aluminum lactate, aluminum oleate, diisopropoxytitanium bis(ethyl acetoacetate) or potassium acetate; compounds containing tertiary amino groups, especially N-ethyldiisopropylamine, N,N,N′,N′-tetramethylalkylenediamines, pentamethylalkylenetriamines and higher homologs thereof, bis(N,N-diethylaminoethyl) adipate, tris(3-dimethylaminopropyl)amine, 1,4-diazabicyclo[2.2.2]octane (DABCO), 1,8-diazabicyclo[5.4.0]undec-7-ene (DBU), 1,5-diazabicyclo[4.3.0]non-5-ene (DBN), N-alkylmorpholines, N,N′-dimethylpiperazine; aromatic nitrogen compounds, such as 4-dimethylaminopyridine, N-methylimidazole, N-vinylimidazole or 1,2-dimethylimidazole; organic ammonium compounds, such as benzyltrimethylammonium hydroxide or alkoxylated tertiary amines; what are called “delayed action” catalysts, which are modifications of known metal or amine catalysts;
rheology modifiers, in particular thickeners, in particular sheet silicates, such as bentonites, derivatives of castor oil, hydrogenated castor oil, polyamides, polyamide waxes, polyurethanes, urea compounds, fumed silicas, cellulose ethers or hydrophobically modified polyoxyethylenes;
solvents, in particular acetone, methyl acetate, tert-butyl acetate, 1-methoxy-2-propyl acetate, ethyl 3-ethoxypropionate, diisopropyl ether, diethylene glycol diethyl ether, ethylene glycol diethyl ether, ethylene glycol monobutyl ether, ethylene glycol mono-2-ethylhexyl ether, acetals such as propylal, butylal, 2-ethylhexylal, dioxolane, glycerol formal or 2,5,7,10-tetraoxaundecane (TOU), toluene, xylene, heptane, octane, naphtha, white spirit, petroleum ether or gasoline, in particular Solvesso™ grades (from Exxon), and propylene carbonate, dimethyl carbonate, butyrolactone, N-methylpyrrolidone, N-ethylpyrrolidone, p-chlorobenzotrifluoride or benzotrifluoride;
natural resins, fats or oils, such as rosin, shellac, linseed oil, castor oil or soybean oil;
nonreactive polymers, especially homo- or copolymers of unsaturated monomers, especially from the group comprising ethylene, propylene, butylene, isobutylene, isoprene, vinyl acetate or alkyl (meth)acrylates, especially polyethylenes (PE), polypropylenes (PP), polyisobutylenes, ethylene/vinyl acetate copolymers (EVA) or atactic poly-α-olefins (APAO);
flame-retardant substances, especially the aluminum hydroxide or magnesium hydroxide fillers already mentioned, and also especially organic phosphoric esters, such as, in particular, triethyl phosphate, tricresyl phosphate, triphenyl phosphate, diphenyl cresyl phosphate, isodecyl diphenyl phosphate, tris(1,3-dichloro-2-propyl) phosphate, tris(2-chloroethyl) phosphate, tris(2-ethylhexyl) phosphate, tris(chloroisopropyl) phosphate, tris(chloropropyl) phosphate, isopropylated triphenyl phosphate, mono-, bis- or tris(isopropylphenyl) phosphates of different degrees of isopropylation, resorcinol bis(diphenylphosphate), bisphenol A bis(diphenylphosphate) or ammonium polyphosphates;
wetting agents, leveling agents, defoamers, deaerators, stabilizers against oxidation, heat, light or UV radiation, or biocides.

It may be advisable for certain additives to undergo chemical or physical drying before being mixed into the composition.

The additives may, if required and depending on the end use, be added in suitable amounts in a customary manner. In general, it is preferable when at least one plasticizer and/or at least one filler are added to the composition.

The proportions of the constituents of the composition may vary within wide ranges depending on the constituents used and the end use. The amounts stated below for appropriate and preferred embodiments relate to the total weight of the polyurethane composition.

The additives are especially added after step b), preferably at a temperature below the reaction temperature in step b), and, if a catalyst is added, it is especially added before step b).

In a preferred embodiment, at least one catalyst as described above is added to the composition before step b), especially a catalyst for the acceleration of the reaction of isocyanate groups, and optionally further additives after step b).

In particular, a composition having the following constituents is produced:
a) 15-70% by weight, preferably 20-60% by weight, in particular 25-50% by weight, of the at least one prepolymer;
b) 0.3-10% by weight, preferably 0.5-7% by weight, in particular 1-5% by weight, of the polycarboxylate, especially as described above;
c) 0-70% by weight, preferably 10-60% by weight, in particular 20-50% by weight, of inorganic and/or organic fillers, especially as described above;
d) 0-30% by weight, preferably 5-25% by weight, in particular 15-25% by weight, of plasticizers, especially as described above;
e) 0-5% by weight, preferably 0.01-3% by weight, in particular 0.05-2% by weight, of at least one catalyst;
f) optionally one or more additional additives, the proportions of which add up to 100% by weight.

The proportions are based here on the total weight of the composition.

Any content of monomeric polyisocyanates, specifically monomeric diisocyanates, here is especially not more than 0.5% by weight, preferably not more than 0.3% by weight, especially not more than 0.1% by weight, specifically less than 0.1% by weight, based on the weight of the prepolymer.

The viscosity may be adjusted as desired taking account of the intended use; for example, the composition may be pasty and may preferably have structurally viscous properties.

Such compositions may be used as polyurethane compositions for various purposes, especially as adhesives and/or sealants.

A further aspect of the present invention therefore relates to a process for producing a polyurethane composition comprising the process as described above.

The invention likewise provides a polyurethane composition obtainable or obtained by the process as described above.

The polyurethane composition may be produced in, or may take, the form of a one-component composition or of a multi-component, in particular two-component, composition. A composition referred to as a “one-component” composition is one in which all constituents of the composition are in the same container and which is storage-stable as is. A composition referred to as a “two-component” composition is one in which the constituents of the composition are present in two different components that are stored in separate containers and are not mixed with one another until shortly before or during the application of the composition.

The polyurethane composition is preferably produced as a one-component composition. Given suitable packaging and storage, it is storage-stable, typically for several months up to one year or longer.

The invention further provides for the use of a polycarboxylate in combination with water for reduction in the content of monomeric polyisocyanates in a composition comprising (i) a prepolymer having isocyanate end groups based on at least one polyisocyanate and at least one polyol, and (ii) at least one monomeric polyisocyanate, wherein the composition comprising the prepolymer and the at least one polyisocyanate is reacted with the polycarboxylate and the water at a temperature of at least 40° C., preferably 50-90° C., in particular 65-80° C., more preferably 70-75° C.

The advantageous embodiments described above in the context of the methods and are also implemented advantageously in the use of the invention.

The invention is further elucidated hereinafter by examples, but these are not intended to restrict the invention in any way.

### Examples

Working examples are adduced hereinafter, which are intended to further elucidate the invention described. The invention is of course not limited to these described working examples.

Unless stated otherwise, the chemicals used were sourced from Sigma-Aldrich (Switzerland).

### Preparation of Prepolymers Having Isocyanate End Groups, Containing Unreacted Monomeric Diisocyanate Radicals:

### Polyurethane Prepolymer PU1:

400 g of polyoxypropylene diol (Acclaim® 4200, from Covestro AG; OH number 28.5 mg KOH/g) and 52 g of diphenylmethane 4,4′-diisocyanate (Desmodur® 44 MC L, from Covestro AG) were reacted by a known procedure at 80° C. to give an NCO-terminated polymer that is liquid at room temperature and has an isocyanate group content of 1.85% by weight, based on the prepolymer.

### Polyurethane Prepolymer PU2:

6950 g of polyoxypropylenepolyoxyethylene triol (Caradol® MD34-02, Shell Chemicals Ltd., UK; OH number 35.0 mg KOH/g), 1145 g of 4,4′-methylene diphenyl diisocyanate (4,4′-MDI; Desmodur® 44 MC L, Bayer MaterialScience AG), and 203 g of diisodecyl phthalate (DIDP; Palatinol® Z, BASF SE, Germany) were reacted at 80° C. by a known method to give an NCO-terminated polyurethane polymer having an isocyanate group content of 2.38% by weight, based on the prepolymer.

### Polyurethane Prepolymer PU3:

590 g of polyoxypropylene diol (Acclaim® 4200 N, Bayer MaterialScience AG; OH number 28.5 mg KOH/g), 1180 g of polyoxypropylenepolyoxyethylene triol (Caradol® MD34-02, Shell Chemicals Ltd., UK; OH number 35.0 mg KOH/g) and 230 g of isophorone diisocyanate (IPDI; Vestanat® IPDI, Evonik Degussa AG) were reacted by a known method at 80° C. to give an NCO-terminated polyurethane polymer having an isocyanate group content of 2.1% by weight, based on the prepolymer.

### Provision of the Polycarboxylate Ether/Water Mixture

A polycarboxylate ether (corresponding to a polymer P as described further up, where the R^{u} and R^{v} radicals in formulae (I) and (II) are hydrogen, r=0, t=1, G¹ and G² are -[A′O]ₛ-G⁴ with s=20-120 and A′=C2-alkylene and G⁴ is a methyl group), available under the ViscoCrete®-520 P trade name (from Sika Schweiz), was spread out over a large area in a room under standard climatic conditions (temperature 23° C. and 50% relative humidity) and left until the water content of the polycarboxylate ether (absorbed water via the air humidity) was 2.5 percent by weight, based on the polycarboxylate ether. The water content was determined via Karl-Fischer titration.

### Production of Polyurethane Compositions

The ingredients specified in table 1 were used to produce four polyurethane compositions C1-C4. Composition C1 was produced for comparative purposes and is not in accordance with the invention.

TABLE 1
Polyurethane compositions (numbers in parts by weight)

Formulation

| Ingredients | C1 | C2 | C3 | C4 |
|---|---|---|---|---|
| Polyurethane prepolymer PU1 | 19 | 19 | 19 | 19 |
| Polyurethane prepolymer PU2 | 26 | 26 | 26 | 26 |
| Polyurethane prepolymer PU3 | 5 | 5 | 5 | 5 |
| Catalyst¹ | 1 | 1 | 1 | 1 |
| Polycarboxylate ether/water² | 0 | 1 | 2 | 4 |
| Plasticizer³ | 9.5 | 9.5 | 9.5 | 9.5 |
| Carbon black⁴ | 23 | 23 | 23 | 23 |
| Inorganic fillers⁵ | 14 | 13 | 12 | 10 |
| Adhesion promoter⁶ | 2.5 | 2.5 | 2.5 | 2.5 |
| TOTAL | 100.0 | 100.0 | 100.0 | 100.0 |

¹dibutyltin diacetate (10% by weight in DIDP)
²mixture of ViscoCrete ®-520 P (from Sika) and 2.5% by weight of water
³diisodecyl phthalate (DIDP)
⁴Monarch ® 570 (from Cabot Corp.)
⁵Omyacarb ® 5 GU (from Omya)
⁶aliphatic polyisocyanate (HDI trimer), Desmodur ® N 3300 (from Covestro)

In a first step, prepolymers PU1 to PU3 and the catalyst were mixed with one another and mixed by means of a planetary mixer for 10 minutes. Then the reaction mixture was heated to a temperature of 65-70° C. and, in experiments C2 to C4, the mixture of polycarboxylate ether and water was added and mixed for 30 minutes. Subsequently, at a temperature of 60-65° C., the plasticizer, the carbon black and the inorganic filler were each added in a known manner. The adhesion promoter was added as the last constituent at 50-55° C. The compositions were stored with exclusion of moisture until use and the implementation of the test protocol as described further down.

### Properties of the Polyurethane Compositions

The monomeric diisocyanate content of the respective composition was determined by means of HPLC (detection via photodiode array; 0.04 M sodium acetate/acetonitrile as mobile phase) after prior derivation by means of N-propyl-4-nitrobenzylamine.

The properties of tensile strength, elongation and 0.5-5% modulus of elasticity were determined according to DIN EN ISO 527 on samples after 7 days at room temperature.

Tack-free time (time until freedom from tack) as a measure of curing rate was determined at 23° C. (“RT”) and 50% relative air humidity. Tack-free time was determined by applying a small portion of the coating composition at room temperature in a layer thickness of about 2 mm to cardboard and determining the time that elapsed before an LDPE pipette used to gently touch the surface of the coating composition was for the first time free of remaining residues.

TABLE 2
Properties of the polyurethane compositions

| | Formulation | | | |
|---|---|---|---|---|
| Property | C1 | C2 | C3 | C4 |
| Monomer content [% by wt.]¹ | | | | |
| 2,4-MDI | 0.02 | 0.01 | <0.01 | n.d. |
| 4,4-MDI | 0.65 | 0.39 | 0.21 | <0.01 |
| IPDI | 0.06 | 0.06 | 0.06 | 0.04 |
| Tensile strength [MPa] | 9.2 | 8.1 | 7.5 | 7.4 |
| Elongation at break [%] | 463 | 402 | 389 | 320 |
| 0.5-5% MoE [MPa] | 4.5 | 4.3 | 3.8 | 2.9 |
| Tack-free time [min] | 42 | 48 | 67 | 53 |

¹based on the respective formulation «n.d.>>» = not determinable

The data in table 2 show that the monomeric polyisocyanate content can be distinctly reduced by reaction with polycarboxylate/water (formulations C2-C4) by comparison with reference formulation C1. This is especially true in the case of MDI. Given a suitable amount of polycarboxylate/water, it is possible to achieve values well below 0.1% by weight for all monomers (formulation C4). This is additionally without any undue impairment of the mechanical properties or tack-free times.

It should be noted that 2,4-MDI is typically present as an impurity in the 4,4-MDI used in the preparation of polymers PU1 and PU2.

Experiments with Separate Addition of Water and Polycarboxylate

Further experiments were conducted with separate addition of polycarboxylate and water, and a comparative experiment without polycarboxylate.

### Experiment C5

This experiment was conducted with the same raw materials and by the same method as experiment C2, except that, rather than 1 part by weight of polycarboxylate ether/water mixture (as in C2), first 2.5 parts by weight of ViscoCrete®-520 P pure polycarboxylate ether (from Sika Schweiz; used as commercially acquired) was added and, within one minute, 0.55 part by weight of water by pipette. The rest of the production process then corresponded exactly to the method of C2.

The testing of the residual monomeric diisocyanate content of experiment C5 by the above-described method as conducted for experiments C1 to C4 gave a content for C5 of <0.01% by weight of 2,4-MDI, 0.07% by weight of 4,4-MDI, and 0.07% by weight of IPDI. The mechanical data were not tested. However, experiment C5 shows that the polycarboxylate and the water need not be added simultaneously (or in the form of a mixture), and that the polycarboxylate can also instead be added in commercial, unprocessed form, and the water can then be added in free form, in order to conduct the method of the invention.

### Experiment C6 (Noninventive)

This experiment was conducted like experiment C5 except that no polycarboxylate, but rather solely 0.55 part by weight of water, was added.

After the water had been added, the reaction mixture started to react in the case of the formulation of C6, and a distinct, ever greater thickening was observed. The experiment ultimately had to be stopped before 30 minutes of stirring time had elapsed since the mixture had begun to cure completely. The residual monomer content could not be determined. Experiment C6 thus shows that polycarboxylate must necessarily be present to enable the effect of the invention. Pure addition of water does not lead to a reduction of the monomer content, but merely to uncontrolled curing of the mixture.

However, the working examples above should be regarded merely as illustrative examples which can be modified as desired within the scope of the invention.

1. A method of reducing the content of monomeric polyisocyanates in a composition comprising (i) at least one prepolymer having isocyanate end groups based on at least one polyisocyanate and at least one polyol, and (ii) at least one monomeric polyisocyanate, wherein the method comprises the following steps:
a) providing the composition comprising the prepolymer and the at least one monomeric polyisocyanate;
b) reacting the composition with a polycarboxylate and water at a temperature of at least 40° C., such that the content of monomeric polyisocyanate in the composition is reduced.

2. The method as claimed in claim 1, wherein the composition is provided in step a) by reacting at least one monomeric polyisocyanate and at least one polyol to give the prepolymer having isocyanate end groups, leaving residues of the monomeric polyisocyanate unreacted in the reaction mixture.

3. The method as claimed in claim 1, wherein the reaction in step b) is conducted in such a way as to result in a content of monomeric polyisocyanates of not more than 0.5% by weight, based on the composition.

4. The method as claimed in claim 1, wherein the composition is reacted in step b) for at least 5 min.

5. The method as claimed in claim 1, wherein the polycarboxylate is a polycarboxylate ether.

6. The method as claimed in claim 1, wherein the polycarboxylate is a polymer P having or consisting of the following component structural units:
b) a molar parts of a component structural unit S1 of the formula I 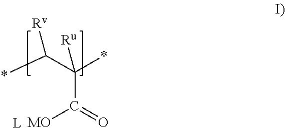
b) b molar parts of a component structural unit S2 of the formula II 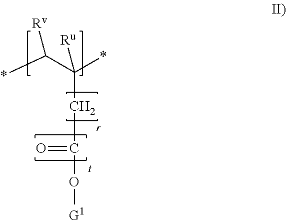
c) c molar parts of a component structural unit S3 of the formula (III) 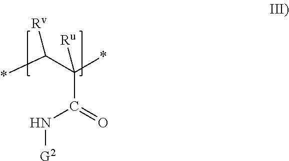
d) d molar parts of a component structural unit S4 of the formula (IV) 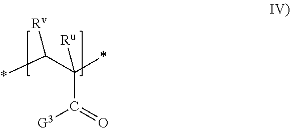
where
L independently represents H⁺, an alkali metal ion, alkaline earth metal ion, a di- or trivalent metal ion, an ammonium ion or an organic ammonium group,
each R^{u} independently of the others is hydrogen or a methyl group,
each R^{v} independently of the others is hydrogen or COOM,
r=0, 1 or 2,
t=0 or 1,
G¹ and G² are independently a C₁- to C₂₀-alkyl group, -cycloalkyl group, -alkylaryl group or -[A′O]ₛ-G⁴,
where A′=C₂- to C₄-alkylene, G⁴ is H, a C₁- to C₂₀-alkyl group, -cycloalkyl group or -alkylaryl group,
and s=2-250,
G³ are independently NH₂, —NG⁵G⁶, —OG⁷NG⁸G⁹, where G⁵ and G⁶ are independently
a C₁- to C₂₀-alkyl group, -cycloalkyl group,
alkylaryl group or -aryl group,
or is a hydroxyalkyl group or is an acetoxyethyl (CH₃—CO—O—CH₂—CH₂—) or a hydroxyisopropyl (HO—CH(CH₃)—CH₂—) or an acetoxyisopropyl group (CH₃—CO—O—CH(CH₃)—CH₂—);
or G⁵ and G⁶ together form a ring of which the nitrogen is part, in order to form a morpholine or imidazoline ring;
G⁷ is a C₂-C₄-alkylene group,
G⁸ and G⁹ each independently represent a C₁- to C₂₀-alkyl group, -cycloalkyl group, -alkylaryl group, -aryl group or a hydroxyalkyl group,
and where a, b, c and d represent molar proportions of the respective component structural units S1, S2, S3 and S4, with
a/b/c/d=(0.1−0.9)/(0.1−0.9)/(0−0.8)/(0−0.8),
especially a/b/c/d=(0.3−0.9)/(0.1−0.7)/(0−0.6)/(0−0.4),
preferably a/b/c/d=(0.5−0.8)/(0.2−0.4)/(0.001−0.005)/0,
and with the proviso that a+b+c+d=1.

7. The method as claimed in claim 1, wherein the polycarboxylate is used in a proportion of 0.5-20% by weight, based on the weight of the prepolymer.

8. The method as claimed in claim 1, wherein the water is used in a proportion of 0.001-1% by weight, based on the weight of the prepolymer.

9. The method as claimed in claim 1, wherein the water is used in a proportion of 0.5-10% by weight, based on the weight of the polycarboxylate.

10. The method as claimed in claim 1, wherein the polyisocyanate comprises a diphenylmethane diisocyanate (MDI).

11. The method as claimed in claim 1, wherein one or more additives that are added to the composition are selected from oligomeric isocyanates, catalysts, fillers, plasticizers, pigments, fibers, nanofillers, dyes, desiccants, adhesion promoters, rheology modifiers, solvents, natural resins, fats or oils, nonreactive polymers, flame-retardant substances, wetting agents, levelling agents, defoamers, deaerating agents, stabilizers against oxidation, against heat, against light or against UV radiation, biocides or mixtures thereof.

12. The method as claimed in claim 11, wherein at least one catalyst for the acceleration of the reaction of isocyanate groups is added prior to step b).

13. A method of producing a polyurethane composition, comprising the method as claimed in claim 1.

14. A polyurethane composition obtainable or obtained by the method as claimed in claim 1.

15. (canceled)
